(19) United States
(12) Patent Application Publication
(10) Pub. No.: US 2007/0107917 A1
(43) Pub. Date: May 17, 2007

(54) Multifunctional robot tool

(76) Inventors: Brian J. Doherty, Weston, MA (US); Michael W. Osborne, Clinton, MA (US); William C. Reynolds, Marlborough, MA (US); Hans A. Hug, Weston, MA (US); Nathan Desmeule, Bellingham, MA (US)

Correspondence Address: IANDIORIO & TESKA;INTELLECTUAL PROPERTY LAW ATTORNEYS, 260 BEAR HILL ROAD, WALTHAM, MA, 02451-1018, US

(21) Appl. No.: 11/355,550

(22) Filed: Feb. 16, 2006

Related U.S. Application Data
(60) Provisional application No. 60/736,612, filed on Nov. 14, 2005.

(51) Int. Cl. A01B 49/02

(52) U.S. Cl. 172/192

(57) ABSTRACT

A multifunctional robot tool includes a pair of driven fingers configured as a gripper and a blade depending from each finger. The blades are configured as a digging spade when closed together by the fingers. A knife is associated with at least one blade for cutting wire.

### RELATED APPLICATIONS

This application claims the benefit of and priority to U.S. Provisional Patent Application Ser. No. 60/736,612 filed Nov. 14, 2005 entitled Robot Technology.

### FIELD OF THE INVENTION

This subject invention relates to a multifunctional tool, and in one example such a tool for a remote control robot.

### BACKGROUND OF THE INVENTION

On the battlefield or otherwise, small, maneuverable, lightweight, remote control robots can be used to minimize human exposure to potentially lethal environments and situations. In one example, remotely controlled robots, such as the Foster-Miller Talon™ robot, have been widely used to detect and disable explosive devices and ordnances in the field including roadside bombs in Iraq. One advantage of using a remotely controlled robot is that it eliminates the need for personnel to approach the explosive device. The individuals controlling the robot may remain at a relatively safe distance, usually a few hundred meters from the explosive device.

Disabling the explosive most often requires that the robot perform multiple operations, including digging to expose the device, gripping to move the device or to remove any covering over the device, and/or cutting to sever control wires and disable the device.

Robots employed to detect and disable explosive devices typically have an arm with an end effecter or tool which is capable of accomplishing only one of these operations. Thus, the operator is required to bring the robot back to his location to change the end effecter to one which is capable of the next operation. In one example, if the explosive is buried or covered, the robot would first have to utilize a digging end effector or tool to uncover the device. Then, the operator would have to bring the robot back to equip it with a gripper to grasp and move the device. If the operator then wished to sever wires, the operator would be required to retrieve the robot again to replace the gripper with a cutter. Typically multiple end effectors which must be changed are heavy and complex. Thus, a robot which requires the operator to bring the robot back to change tools reduces the overall efficiency of the operation. Additionally, the time required for the robot to travel back and forth extends the time that the explosive device presents a hazard. Also, when operations are carried out in a hostile environment, the amount of time the operator and other personnel are exposed to potential attack is increased.

With the widespread use of the improvised explosive devices (IEDs) or roadside bombs and other similar devices by terrorists in places like Iraq and Afghanistan, the need to improve both the efficiency and capabilities of these robots has intensified.

### SUMMARY OF THE INVENTION

It is therefore an object of this invention to provide an improved tool for a robot such as a remote control robot.

It is a further object of this invention to provide such a tool which is multifunctional.

It is a further object of this invention to provide such a tool which reduces or eliminates the necessity to retrieve a robot in order to change tools.

It is a further object of this invention to provide a multifunctional tool as an alternative to and improvement over tools having a single function.

The subject invention results from the realization that improvement over single function tools can be achieved by a tool having multiple capabilities, and which does not require components to be changed in order to shift from one function to another. The invention results from the further realization that, in one example, such a multifunctional tool can be used with a remote control robot to increase the efficiency of the robot, and thus decrease the amount of time that individuals near the robot's working area are exposed to danger.

The subject invention, however, in other embodiments, need not achieve all these objectives and the claims hereof should not be limited to structures or methods capable of achieving these objectives.

The subject invention features a multifunctional robot tool including a pair of driven fingers configured as a gripper. A blade depends from each finger and the blades are configured as a digging spade when closed together by the fingers. A knife is associated with at least one blade for cutting wire. In one example, the multifunctional robot tool further includes an enclosed gear box including upwardly extending drive shafts each received in a rearward clamp in each finger. Each blade may include a rearwardly extending frame member removably securable to a side of a finger. The knife typically includes a concave cutter extending outwardly from a first blade and a socket extending inwardly from a second blade for receiving the cutter. The cutter may be fixed to a C-channel member secured over an inside edge of the first blade. In one example, the inside edge of the first blade includes a cut-out for receiving the c-channel member, and the socket includes a first plate secured over a cut-out in the second blade, and a second plate is secured behind the cut-out in the second blade. The second plate may include a concave cutter. Each finger may include concave portion and a distal gripping plate. In one embodiment the rearwardly extending frame members each may include a beveled portion forming an edge of a blade, and the rearwardly extending frame members each may include a beveled portion forming part of the digging spade.

The subject invention also features a multifunctional robot tool including a pair of driven fingers configured as a gripper and a blade depending from each finger. The blades are configured as a digging spade when closed together by the fingers, and each blade includes a rearwardly extending frame member removably securable to a side of a finger. A knife is associated with at least one blade for cutting wire, and an enclosed gear box includes an upwardly extending drive shaft received in a rearward clamp in each finger.

The subject invention further features a multifunctional robot tool including a pair of driven fingers configured as a gripper, and a blade depending from each finger, the blades configured as a digging spade when closed together by the fingers.

The subject invention also features a robot comprising a track driven body, an articulable main arm, and a pair of driven fingers configured as a gripper on the articulable main arm. A blade depends from each finger, and the blades are configured as a digging spade when closed together by the pair of driven fingers.

### BRIEF DESCRIPTION OF THE DRAWINGS

Other objects, features and advantages will occur to those skilled in the art from the following description of a preferred embodiment and the accompanying drawings, in which:

FIG. 1 is a schematic representation of one example of a remotely controlled robot which may include the multifunctional robot tool of the present invention;

FIG. 2 is a schematic three-dimensional view of one embodiment of a multifunctional robot tool in accordance with the present invention;

FIG. 3 is a more detailed schematic view of one example of the knife and digging blades of the multifunctional robot tool of FIG. 2;

FIGS. 4 and 5 are exploded schematic views of the multifunctional robot tool components shown in FIG. 3; and

FIGS. 6-8 are schematic side views of the multifunctional robot tool components shown in FIGS. 4 and 5.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

As discussed in the Background section above, robots have been widely used in place of human action when harmful and/or hazardous environmental conditions are present. Remote control robots, such as the Foster-Miller Talon™ robot, have been utilized when conditions necessitate operating the robot from afar, for example, to retrieve information or perform tasks which require the robot to enter into a dangerous area or situation.

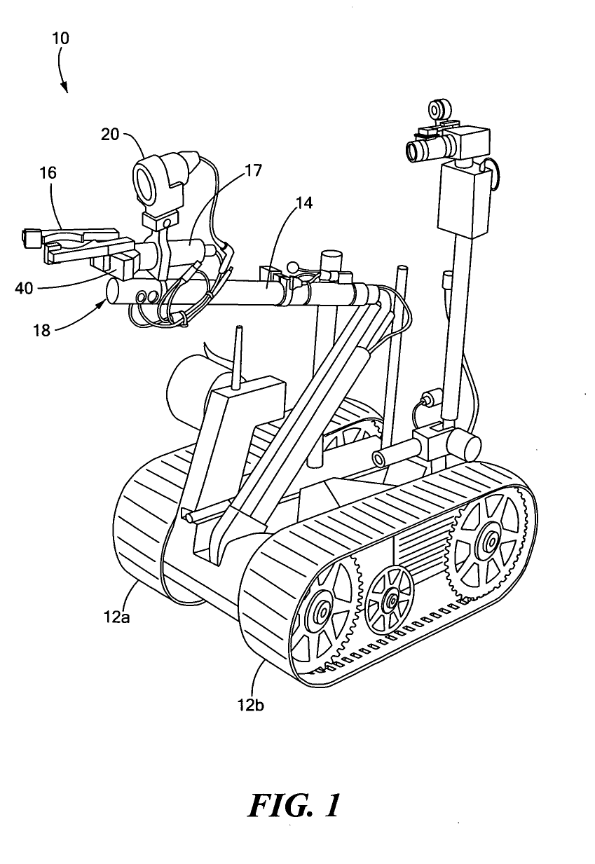

One example of a remote control robot is shown in FIG. 1. Remote control robot or robotic vehicle 10 often includes tracks 12a and 12b for mobility. Articulating arm 14 of vehicle 10 typically includes end effecter or single purpose tool 16 at distal end 18 of arm 14. As shown, single purpose tool 16 is a gripper. Motor 17 actuates the gripping function via gear box 40. Camera 20 sends visual signals of tool 16, as well as the explosive device or object on which tool 16 is working, to the operator of robot 10. In this way, robot 10, arm 14 and tool 16 can be maneuvered by the operator as appropriate.

It was discovered that a conventional end effecter or single purpose tool 16 is less than ideal in the field. When more than one operation by robot 10 is required to uncover and disarm an IED, for example, tool 16 often must be changed. In order to change the tool, the operator must retrieve robot 10 between these operations. The time period from a robot's initial contact with the IED until the moment when the IED is finally disarmed is critical, however, because during that time the IED remains a threat to anyone in the area. In a battlefield scenario, changing the tools may be difficult, and the operator and others may themselves be subject to attack. In sum, the shorter the length of time it takes to disable the explosive, the better for the robot operator, military personnel and civilians.

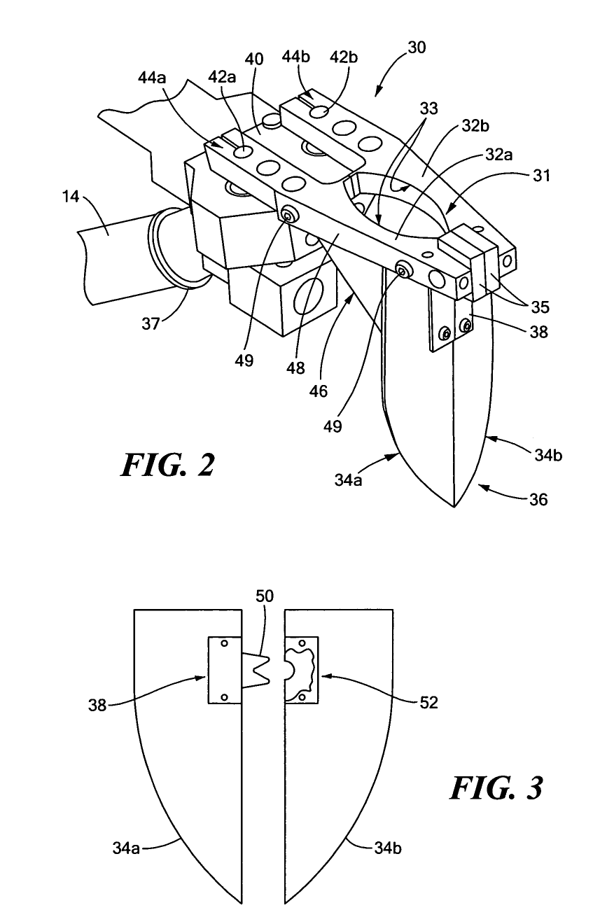

The inventors hereof observed that if the tool changing steps could be eliminated, the explosive could be disarmed faster and more efficiently. To achieve that end, the inventors devised the multifunctional tool shown in FIGS. 2-8.

One example of a multifunctional robot tool in accordance with the present invention is shown in FIG. 2. Multifunctional robot tool 30 includes a pair of driven fingers 32a and 32b configured as a gripper 31, with blades 34a and 34b depending from fingers 32a and 32b, respectively. Blades 34 are configured as digging spade 36 when closed together by arms 32. Knife 38 is associated with at least one blade 34a, typically for cutting wire.

Thus, multiple tools with different capabilities are combined in a single mechanism. Notably, this multifunctional robot tool requires only one motor—typically included in remote control robots—to actuate the multiple functions. The motor which actuates fingers 32a and 32b of gripper 31 also actuates knife 38 for wire cutting. Blades 34a and 34b depend from the fingers in a manner that positions them as a unified digging spade 36 when gripper 31 is closed and moves fingers 32a and 32b such that they do not obstruct the ability of gripper 31 to reach and hold objects.

Multifunctional robot tool 30 of the present invention provides the capabilities needed to disable an IED, for example, include gripping, digging and cutting, and does so without having to retrieve the robot and/or change tools. The pair of driven fingers 32a and 32b provide gripping ability, such as when it is necessary to grip and carry the explosive or other object. When blades 34a and 34b are closed together by fingers 32a and 32b, the blades form digging spade 36. Thus, if the explosive or IED is buried, multifunctional robot tool 30 provides digging capability. Knife 38 provides the ability for multifunctional robot tool 30 to cut wires of the explosive device, for example. In summary, a buried IED with detonation wiring may be dug up, gripped and carried to a safer area, where the wiring may be severed to safely disarm the device. The multifunctional robot tool of the present invention may be utilized for any combination of gripping, digging up and cutting of any type of device, depending on the particular application or scenario. Thus, versatility and efficiency are increased and the time needed to disable the device is decreased, resulting in a safer operation.

In one embodiment, multifunctional tool 30 includes enclosed gear box 40, which itself includes upwardly extending drive shafts 42a and 42b received in rearward clamps 44a and 44b in each finger 32a and 32b, respectively. Gear box 40 protects the gears therein from harsh environmental conditions. Each blade 34 includes rearwardly extending frame member 46 which is removably securable to side 48 of finger 32, for instance, by fasteners 49 such as screws. In one example, each finger 32 includes concave portion 33, and each finger 32 may include a distal gripping plate 35. Preferably, lockable rotary joint 37 connects multifunctional tool 30 with arm 14 which connects to the main portion of the robot, as shown for instance in FIG. 1. Lockable rotary joint 37 allows multifunctional robot tool 30 to be oriented at an optimal angle relative to arm 14 and to be securely locked in place.

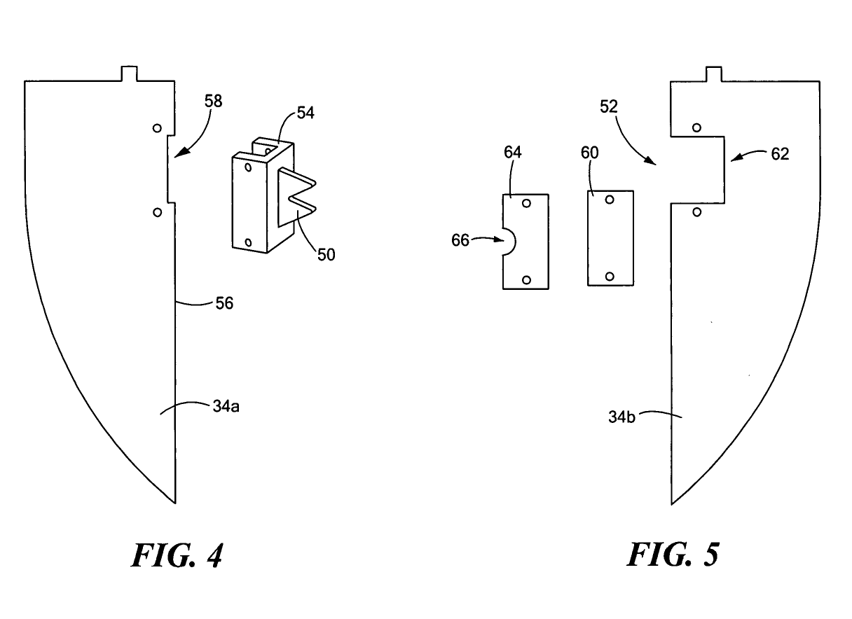

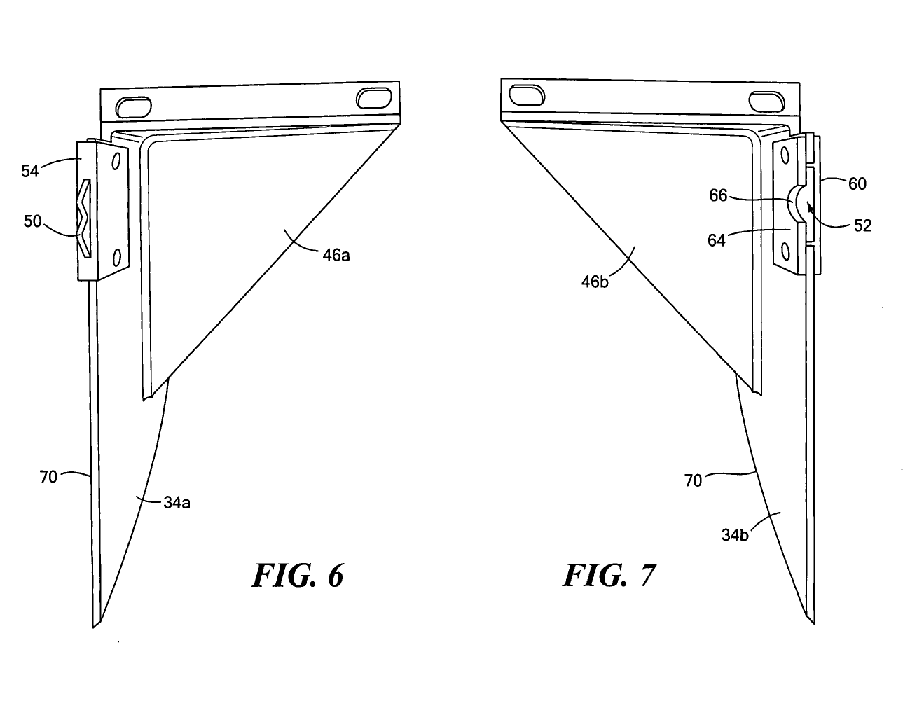

In one example, knife 38, FIG. 3 includes concave cutter 50 extending outwardly from blade 34a and socket 52 extendingly inwardly from blade 34b for receiving cutter 50. Cutter 50, FIG. 4 is fixed to a C-channel member 54 secured over inside edge 56 of blade 34a. Inside edge 56 of blade 34a includes cut-out 58 for receiving C-channel member 54. Socket 52, FIG. 5 includes plate 60 secured over cut-out 62 in blade 34b. Socket 52 also includes plate 64 secured behind cut-out 62 in blade 34b. Preferably, plate 64 includes concave cutter 66. In this way, knife 38 is designed into the digging spade in a manner that protects cutter 50 when the gripper is held in the closed position and the multifunctional tool is used for digging. This design also allows a wire to be held and cut when the gripper fingers are actuated (opened and then closed). Socket 52, C-channel member 54, cut-outs 58 and 62, and plates 60 and 64 ensure proper alignment of cutter 50 and concave cutter 66 as these two pieces are brought together by closing the fingers of the gripper. Also, when knife blade 50, FIG. 3 is received in channel 52, blades 34a and 34b are locked together for digging operations.

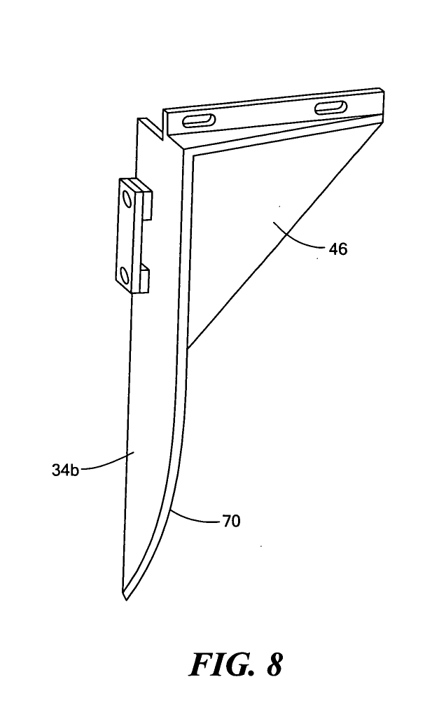

Further, as shown in FIGS. 6-8, one embodiment of multifunctional robot tool of this invention includes blades 34a and 34b each having beveled portion 70 forming an edge of each blade 34a and 34b, thus forming outer edges of digging spade 36, FIG. 2.

Thus, the subject invention provides a multifunctional robot tool which reduces or eliminates the necessity to retrieve the robot in order to change the tool configurations and which clearly provides an improvement over tools having a single function.

The multifunctional robot tool of the subject invention has been discussed generally in connection with anti-terrorist activities, battlefield scenarios, and remote control robots. The subject invention, however, is not necessarily so limited. The multifunctional robot tool of this invention may be used in any environment or under any conditions which may prove harmful or fatal to humans, such as toxic or radioactive areas for example. Furthermore, the multifunctional robot tool of the present invention may be used with any type of robot or mechanical apparatus, whether controlled remotely or not, including a robot as described herein or otherwise.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

What is claimed is:

1. A multifunctional robot tool comprising:
a pair of driven fingers configured as a gripper;
a blade depending from each finger, the blades configured as a digging spade when closed together by the fingers; and
a knife associated with at least one blade for cutting wire.

2. The multifunctional robot tool of claim 1 further including an enclosed gear box including upwardly extending drive shafts each received in a rearward clamp in each finger.

3. The multifunctional robot tool of claim 1 in which each blade includes a rearwardly extending frame member removably securable to a side of a finger.

4. The multifunctional robot tool of claim 1 in which the knife includes a concave cutter extending outwardly from a first blade and a socket extending inwardly from a second blade for receiving the cutter.

5. The multifunctional robot tool of claim 4 in which the cutter is fixed to a C-channel member secured over an inside edge of the first blade.

6. The multifunctional robot tool of claim 5 in which the inside edge of the first blade includes a cut-out for receiving the C-channel member.

7. The multifunctional robot tool of claim 4 in which the socket includes a first plate secured over a cut-out in the second blade.

8. The multifunctional robot tool of claim 7 in which the socket further includes a second plate secured behind the cut-out in the second blade.

9. The multifunctional robot tool of claim 8 in which the second plate includes a concave cutter.

10. The multifunctional robot tool of claim 1 in which each finger includes concave portion.

11. The multifunctional robot tool of claim 1 in which each finger includes a distal gripping plate.

12. The multifunctional robot tool of claim 3 in which the blades each include a beveled portion forming an edge of each blade.

13. The multifunctional robot tool of claim 3 in which the blades each include a beveled portion forming outer edges of the digging spade.

14. A multifunctional robot tool comprising:
a pair of driven fingers configured as a gripper;
a blade depending from each finger, the blades configured as a digging spade when closed together by the fingers, each blade including a rearwardly extending frame member removably securable to a side of a finger;
a knife associated with at least one blade for cutting wire; and
an enclosed gear box including an upwardly extending drive shaft received in a rearward clamp in each finger.

15. A multifunctional robot tool comprising:
a pair of driven fingers configured as a gripper;
a blade depending from each finger, the blades configured as a digging spade when closed together by the fingers.

16. A robot comprising:
a track driven body;
an articulable main arm;
a pair of driven fingers configured as a gripper on the articulable main arm; and
a blade depending from each finger, the blades configured as a digging spade when closed together by the pair of driven fingers.
